(19) United States
(12) Patent Application Publication
(10) Pub. No.: US 2025/0348024 A1
(43) Pub. Date: Nov. 13, 2025

(54) IMAGE FORMING APPARATUS AND DEVELOPING DEVICE

(71) Applicant: FUJIFILM Business Innovation Corp., Tokyo (JP)

(72) Inventors: Masanori KATO, Kanagawa (JP); Mitsutoshi HONGO, Kanagawa (JP); Yoshihisa NAKAO, Kanagawa (JP); Taiyou UEHARA, Kanagawa (JP)

(73) Assignee: FUJIFILM Business Innovation Corp., Tokyo (JP)

(21) Appl. No.: 18/925,072

(22) Filed: Oct. 24, 2024

(30) Foreign Application Priority Data
May 10, 2024 (JP) 2024-076959

(51) Int. Cl. G03G 15/08; G03G 15/01

(52) U.S. Cl. CPC G03G 15/0891; G03G 15/0121; G03G 2215/0624

(57) ABSTRACT

An image forming apparatus includes plural image holding bodies and plural developing devices that respectively develop images on the image holding bodies by using developers that are different from each other in fluidity, in which each of the developing devices includes an accommodation portion that accommodates a developer and that includes a first transport path extending in one direction, a second transport path disposed below the first transport path and extending in the one direction, a first connection portion connecting one end of the first transport path and one end of the second transport path to each other, and a second connection portion connecting the other end of the first transport path and the other end of the second transport path to each other, a first transport member that is disposed in the first transport path and that transports the developer from one end to the other end in the one direction, a second transport member that is disposed in the second transport path and that transports the developer from the other end to the one end in the one direction, a discharge path that extends in the one direction from the one end of the first transport path and through which the developer flowing out from the first transport path is discharged to an outside of the accommodation portion, and a discharge transport member that is disposed in the discharge path and that transports the developer flowing out from the first transport path, and the lower a fluidity of the developer to be accommodated in the accommodation portion is, the more the discharge path, the discharge transport member, the first transport path of the accommodation portion, or the first connection portion is shaped to facilitate discharge of the developer to the outside of the accommodation portion.

### CROSS-REFERENCE TO RELATED APPLICATIONS

This application is based on and claims priority under 35 USC 119 from Japanese Patent Application No. 2024-076959 filed May 10, 2024.

### BACKGROUND

### (i) Technical Field

The present invention relates to an image forming apparatus and a developing device.

### (ii) Related Art

Disclosed in JP2012-163791A is a developing device including a housing that accommodates a developer and a first agitating and transporting member and a second agitating and transporting member that are accommodated in the housing and that agitate and transport the developer. In the developing device, a surplus of the developer is discharged to the outside of the housing through a discharge port provided at one end of the housing.

### SUMMARY

In a case where structures for discharge of surpluses of developers in developing devices to the outside of accommodation portions are uniform with each other, the amount of discharge of the developers may be insufficient or excessive due to a difference in fluidity between the developers. In this case, the amounts of developers accommodated in the accommodation portions are likely to be unstable.

Aspects of non-limiting embodiments of the present disclosure relate to an image forming apparatus and a developing device that stabilize the amounts of developers accommodated in accommodation portions in comparison with a case where structures for discharge of surpluses of the developers to the outside of accommodation portions are uniform with each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a plurality of image holding bodies and a plurality of developing devices that respectively develop images on the image holding bodies by using developers that are different from each other in fluidity, in which each of the developing devices includes an accommodation portion that accommodates a developer and that includes a first transport path extending in one direction, a second transport path disposed below the first transport path and extending in the one direction, a first connection portion connecting one end of the first transport path and one end of the second transport path to each other, and a second connection portion connecting the other end of the first transport path and the other end of the second transport path to each other, a first transport member that is disposed in the first transport path and that transports the developer from one end to the other end in the one direction, a second transport member that is disposed in the second transport path and that transports the developer from the other end to the one end in the one direction, a discharge path that extends in the one direction from the one end of the first transport path and through which the developer flowing out from the first transport path is discharged to an outside of the accommodation portion, and a discharge transport member that is disposed in the discharge path and that transports the developer flowing out from the first transport path, and the lower a fluidity of the developer to be accommodated in the accommodation portion is, the more the discharge path, the discharge transport member, the first transport path of the accommodation portion, or the first connection portion is shaped to facilitate discharge of the developer to the outside of the accommodation portion.

### BRIEF DESCRIPTION OF THE DRAWINGS

Exemplary embodiment(s) of the present invention will be described in detail based on the following figures, wherein:

FIG. 1 is a view showing an image forming apparatus according to the present exemplary embodiment;

FIG. 2 is a view of a developing device as seen from above;

FIG. 3 is a cross-sectional view of the developing device taken along line III-III in FIG.

2;

FIG. 4 is a cross-sectional view of the developing device taken along line IV-IV in FIG. 2;

FIGS. 5A and 5B are views for description of an example of a configuration of a transport member;

FIG. 6 is a view for description of a configuration of the developing device on one end side in a longitudinal direction;

FIG. 7 is a view for description of a configuration of a developing device of a special color image forming unit;

FIG. 8 is a view for description of a configuration of a developing device of a metallic color image forming unit; and

FIG. 9 is a table showing the types of attachment portions, cover portions, and transport members to be combined with developing devices.

### DETAILED DESCRIPTION

An exemplary embodiment of the present invention will be described below with reference to the accompanying drawings.

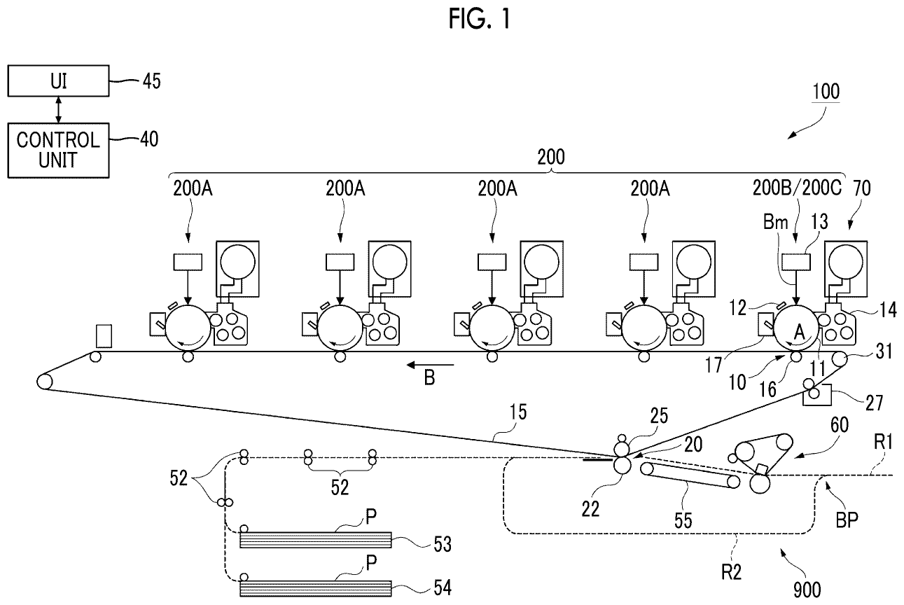

FIG. 1 is a view showing an image forming apparatus 100 according to the present exemplary embodiment. FIG. 1 shows a state related to a case where the image forming apparatus 100 is seen from a side ahead of the image forming apparatus 100.

The image forming apparatus 100 is an intermediate transfer type image forming apparatus 100, which is called a tandem type image forming apparatus.

The image forming apparatus 100 is provided with a plurality of image forming units 200 that form images to be transferred to a paper sheet P, which is an example of a recording medium. The image forming units 200 are arranged at predetermined distances in a horizontal direction. Each image forming unit 200 or a portion of a constituent member of each image forming unit 200 may be a process cartridge that is attachable to and detachable from the image forming apparatus 100.

Each of the image forming units 200 includes a photoreceptor drum 11, which is an example of an image holding body, and forms a toner image, which is an image to be transferred to the paper sheet P, on the photoreceptor drum 11 by using a developer containing toner. In other words, each of the image forming units 200 forms, on the photoreceptor drum 11 by using a powdery developer, a toner image to be transferred to the paper sheet P.

A developer of the present exemplary embodiment is composed of a dry carrier and dry toner. Each of the image forming units 200 uses a carrier and toner to form a toner image on the photoreceptor drum 11.

Five image forming units 200 form toner images on the photoreceptor drums 11 by using different types of developers.

Specifically, in the present exemplary embodiment, four of the five image forming units 200 form toner images by using developers of basic colors which are yellow, magenta, cyan, and black. In the following description, the four image forming units 200 that form toner images by using the developers of the basic colors may be referred to as basic color image forming units 200A.

In addition, the remaining one image forming unit 200 other than the basic color image forming units 200A forms a toner image by using a developer of a color other than the basic colors. In this example, the image forming unit 200 positioned closest to a right side in FIG. 1 forms a toner image by using the developer of a color other than the basic colors.

More specifically, the remaining one image forming unit 200 forms a toner image by using the developer of a color other than the basic colors, such as clear, white, pink, green, or orange, or a developer that has metallic glossiness like gold, silver, or the like. In the following description, a developer that has a color other than the basic colors and that does not have metallic glossiness will be referred to as a developer of a special color. In addition, the image forming unit 200 that forms a toner image by using the developer of the special color will be referred to as a special color image forming unit 200B. Furthermore, a developer that has metallic glossiness will be referred to as a developer of a metallic color. Toner of the developer of the metallic color is colored with a metallic pigment, for example. In addition, the image forming unit 200 that forms a toner image by using the developer of the metallic color will be referred to as a metallic color image forming unit 200C.

In the image forming apparatus 100 of the present exemplary embodiment, it is possible to switch one image forming unit 200 with the special color image forming unit 200B or the metallic color image forming unit 200C by attaching and detaching a process cartridge with respect to the image forming apparatus 100.

In the present exemplary embodiment, a so-called two-component developer in which a carrier and toner are mixed with each other is used as the developer. The type of carrier and the type of toner to be mixed are different depending on the type of a developer. Accordingly, the fluidity of a developer may differ depending on the type of the developer. The fluidity of a developer is the degree to which the developer easily flows. The higher the fluidity of a developer is, the more easily the developer flows and moves. In addition, the lower the fluidity of a developer is, the more difficult it is for the developer to flow and move.

In the present exemplary embodiment, the developers of the basic colors, the developer of the special color, and the developer of the metallic color are different from each other in fluidity. More specifically, the fluidities thereof descend in the order of the developers of the basic colors, the developer of the special color, and the developer of the metallic color. In other words, among the developers of the basic colors, the developer of the special color, and the developer of the metallic color, the developers of the basic colors are the highest in fluidity and the developer of the metallic color is the lowest in fluidity.

The fluidity of a developer depends on, for example, the particle sizes of a carrier and toner contained in the developer, the material of the carrier or the toner, the shape of the carrier, a mixing ratio between the carrier and the toner, and the like.

Note that the developer of a color other than the basic colors is not limited to the developer of the special color and the developer of the metallic color which have been described above. Examples of the developer of a color other than the basic colors include a developer containing magnetic toner and a developer containing conductive toner in addition to the developer of the special color and the developer of the metallic color. In addition, examples of the developer of a color other than the basic colors include a developer containing toner that emits light in a case where the toner is irradiated with light such as ultraviolet rays or infrared rays. Such developers are also different from the developers of the basic colors in fluidity since a carrier and toner thereof are different from a carrier and toner of the developers of the basic colors.

In addition, in the image forming apparatus 100 of the present exemplary embodiment, three types of developers, which are the developers of the basic colors, the developer of the special color, and the developer of the metallic color, are used as developers that are different in fluidity. However, the present invention is not limited thereto. In the image forming apparatus 100, two types of developers different in fluidity may be used or four or more types of developers may be used. In addition, two or more types of developers of the basic colors that are different from each other in fluidity may also be used.

In the present exemplary embodiment, a so-called two-component developer in which a carrier and toner are mixed with each other is used as the developer. However, the present invention is not limited thereto, and a so-called one-component developer composed of toner only may also be used.

In addition, the image forming apparatus 100 is provided with an intermediate transfer belt 15 and primary transfer units 10 provided to transfer toner images to the intermediate transfer belt 15, the toner images being respectively formed by the image forming units 200.

Furthermore, the image forming apparatus 100 is provided with a secondary transfer unit 20 provided to transfer, to the paper sheet P, the toner images transferred onto the intermediate transfer belt 15.

In addition, the image forming apparatus 100 is provided with a fixing device 60 that fixes, onto the paper sheet P, the toner images transferred onto the paper sheet P.

Furthermore, the image forming apparatus 100 is provided with a control unit 40 that includes a CPU executing a program and that controls each unit in the image forming apparatus 100.

In addition, the image forming apparatus 100 is provided with a user interface (UI) 45 that is composed of a display panel or the like, that receives an instruction from a user, and that displays information with respect to the user.

Each of the image forming units 200 is provided with a developing device 14. In addition, each of the image forming units 200 is provided with a developer replenishment device 70 that replenishes the developing device 14 with a developer.

The developing device 14 visualizes an electrostatic latent image on the photoreceptor drum 11 with toner. In other words, the developing device 14 performs photographic development with respect to the photoreceptor drum 11, which is an image holding body, to form, on the photoreceptor drum 11, an image formed by the toner.

Although details will be described later, in the present exemplary embodiment, the structures of the developing devices 14 of the basic color image forming units 200A, the special color image forming unit 200B, and the metallic color image forming unit 200C are partially different from each other.

The developer replenishment device 70 replenishes the developing device 14 with a developer. As described above, a developer is composed of a carrier and toner, and the developer replenishment device 70 replenishes the developing device 14 with a carrier and toner as a developer. Note that in the present exemplary embodiment, a carrier has a positive charging polarity, and toner has a negative charging polarity.

In each of the image forming units 200, the photoreceptor drum 11 which is an example of an image holding body rotates in a direction along an arrow A.

In addition, each of the image forming units 200 is provided with a charger 12 that charges the photoreceptor drum 11 and a laser exposure device 13 which is an example of an exposure device forming an electrostatic latent image on the photoreceptor drum 11. In FIG. 1, an exposure beam from the laser exposure device 13 is represented by a reference numeral “Bm”. Note that the exposure device may be composed of a device including a light source, such as an LED.

In addition, each of the image forming units 200 is provided with a primary transfer roll 16 that transfers a toner image formed on the photoreceptor drum 11 to the intermediate transfer belt 15 at the primary transfer unit 10. In addition, each of the image forming units 200 is provided with a drum cleaner 17 that removes a developer remaining on the photoreceptor drum 11.

A drive roll 31 driven by a motor (not shown) causes the intermediate transfer belt 15 to circulate and move at a predetermined speed in a direction along an arrow B which is shown in FIG. 1.

The primary transfer unit 10 is configured to include the primary transfer roll 16 that is disposed to face the photoreceptor drum 11 with the intermediate transfer belt 15 interposed therebetween. In addition, respective toner images on the photoreceptor drums 11 are electrostatically attracted onto the intermediate transfer belt 15 in order, so that superimposed toner images are formed on the intermediate transfer belt 15.

The secondary transfer unit 20 which is an example of a transfer unit is configured to include a secondary transfer roll 22 that is disposed on an outer surface side of the intermediate transfer belt 15 and a backup roll 25 that is disposed on an inner surface side of the intermediate transfer belt 15.

In the present exemplary embodiment, at the secondary transfer unit 20, toner images that are formed by the image forming units 200 and that are transferred to the intermediate transfer belt 15 are transferred to the paper sheet P transported to the secondary transfer unit 20.

Furthermore, in the present exemplary embodiment, an inversion mechanism 900 that inverts the paper sheet P is provided.

The inversion mechanism 900 inverts the paper sheet P with one surface on which the toner images have been transferred at the secondary transfer unit 20 upside down and supplies the paper sheet P again to the secondary transfer unit 20.

Accordingly, in the present exemplary embodiment, toner images can be formed on both surfaces of the paper sheet P.

Specifically, in the present exemplary embodiment, the inversion mechanism 900 inverts the paper sheet P upside down by feeding the paper sheet P, which has passed through the fixing device 60, to a branch path R2 branching off a paper sheet transport path R1. Specifically, after the paper sheet P passes through a branching portion BP, the inversion mechanism 900 transports the paper sheet P in a reverse direction and feeds the paper sheet P to the branch path R2.

The branch path R2 joins the paper sheet transport path R1 at a position upstream of the secondary transfer unit 20. Accordingly, in the present exemplary embodiment, the paper sheet P inverted upside down is supplied again to the secondary transfer unit 20. In this case, toner images are formed not only on the one surface of the paper sheet P but also on the other surface of the paper sheet P, so that the toner images are formed on both surfaces of the paper sheet P.

The flow of processing performed in the image forming apparatus 100 will be described.

The image forming apparatus 100 receives image data output from, for example, an image reading apparatus (not shown) or a computer. Then, the image data is subjected to image processing. Accordingly, image data corresponding to each of the plurality of image forming units 200 is generated.

Specifically, for example, image data used for image formation in which the developers of the basic colors, which are yellow, magenta, cyan, and black, are used and image data used for image formation in which the developer of a color other than the basic colors is used are generated. The generated image data is output to the laser exposure devices 13 provided at the image forming units 200.

In accordance with the image data input to the laser exposure devices 13, the laser exposure devices 13 irradiate the photoreceptor drums 11 with the exposure beams Bm emitted from, for example, semiconductor lasers.

In the present exemplary embodiment, after respective surfaces of the photoreceptor drums 11 are charged by the chargers 12, the surfaces are scanned and exposed to light by the laser exposure devices 13. Accordingly, electrostatic latent images are formed on the surfaces of the photoreceptor drums 11.

Next, development processing is performed by the developing devices 14 so that toner images are formed on the photoreceptor drums 11. The toner images are transferred onto the intermediate transfer belt 15 at the primary transfer units 10.

After the toner images are transferred onto the intermediate transfer belt 15, the toner images are moved to the secondary transfer unit 20 as the intermediate transfer belt 15 moves. In addition, at this time, the paper sheet P from a first paper sheet accommodation portion 53 or a second paper sheet accommodation portion 54 is transported to the secondary transfer unit 20 by transport rolls 52 or the like.

Then, the toner images on the intermediate transfer belt 15 are electrostatically transferred onto the paper sheet P in a collective manner at the secondary transfer unit 20.

Thereafter, the paper sheet P onto which the toner images have been transferred is peeled from the intermediate transfer belt 15 and is transported to a transport belt 55. The transport belt 55 transports the paper sheet P to the fixing device 60.

The paper sheet P transported to the fixing device 60 is heated and pressed by the fixing device 60. Accordingly, the toner images on the paper sheet P are fixed to the paper sheet P. Then, the paper sheet P is discharged from the image forming apparatus 100.

Note that in a case where toner images are to be formed on both surfaces of the paper sheet P, the paper sheet P is supplied again to the secondary transfer unit 20 through the branch path R2 after the paper sheet P passes through the fixing device 60.

Then, toner images are transferred to the other surface of the paper sheet P at the secondary transfer unit 20. Thereafter, the paper sheet P passes through the fixing device 60 again and the toner images transferred to the other surface are fixed to the paper sheet P.

The developing devices 14 will be described. As described above, in the present exemplary embodiment, the structures of the developing devices 14 of the basic color image forming units 200A, the special color image forming unit 200B, and the metallic color image forming unit 200C are partially different from each other. Here, a configuration common to the developing devices 14 of the basic color image forming units 200A, the special color image forming unit 200B, and the metallic color image forming unit 200C will be described.

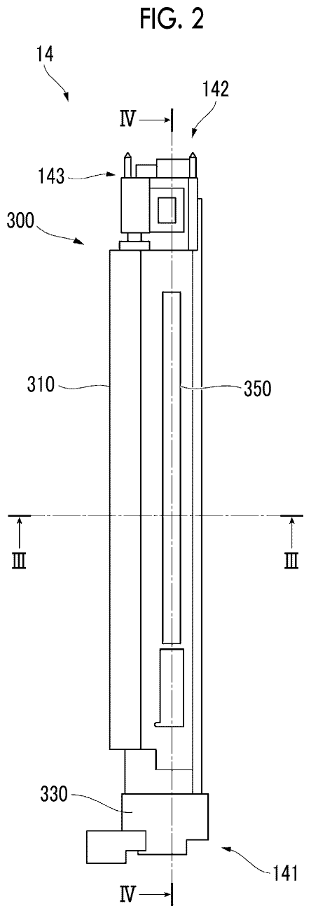

FIG. 2 is a view of the developing device 14 as seen from above.

In a case where the developing device 14 is installed in the image forming apparatus 100, the developing device 14 is disposed along a depth direction of the image forming apparatus 100. The developing device 14 includes one end portion 141 and the other end portion 142, of which the positions are different from each other in a longitudinal direction.

In a case where the developing device 14 is installed in the image forming apparatus 100, the developing device 14 is installed in the image forming apparatus 100 such that the one end portion 141 is positioned on a front side of the image forming apparatus 100 and the other end portion 142 is positioned on a rear side of the image forming apparatus 100.

A drive force receiving portion 143 that receives a drive force is provided at the other end portion 142 of the developing device 14.

In the present exemplary embodiment, a drive force from a drive source (not shown), such as a motor, is transmitted to the drive force receiving portion 143, the drive source being provided on a body side of the image forming apparatus 100.

The drive force receiving portion 143 is linked to a member or the like (which will be described later) provided inside the developing device 14. In the present exemplary embodiment, the member or the like is rotated as the drive force from the drive source is transmitted to the drive force receiving portion 143.

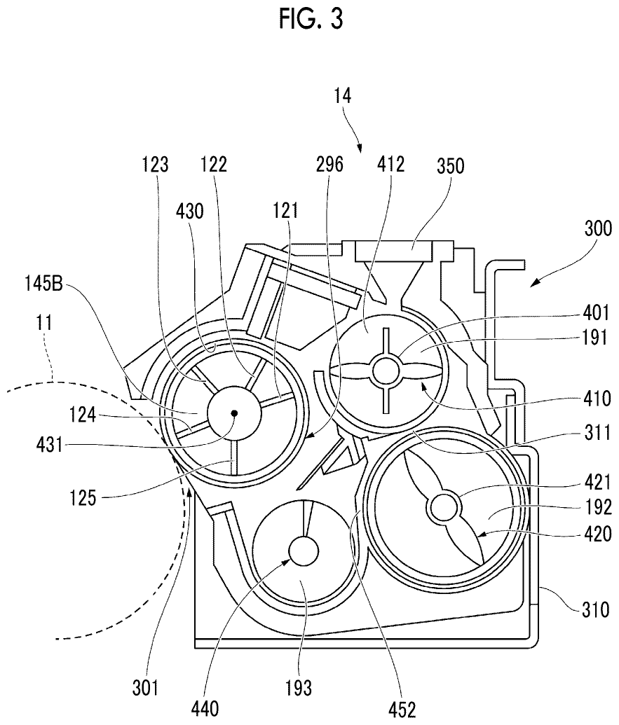

In the present exemplary embodiment, as will be described later, a transport member 400, a second transport member 420, a facing member 430, and a lower-side transport member 440 (refer to FIG. 3 which will be described later) are provided as members that rotate as the drive force is received from the drive source. The drive force receiving portion 143 may be provided to correspond to each of the four members. In addition, a drive force from the drive source may be transmitted to each of four drive force receiving portions 143.

In addition, alternatively, drive force receiving portions 143 of which the number is smaller than the number of the four members (for example, one drive force receiving portion 143) may be provided. In addition, a drive force transmitted from the drive source to the drive force receiving portion 143 may be transmitted to each of the four members through a transmission mechanism (not shown) provided at the developing device 14.

FIG. 3 is a cross-sectional view of the developing device 14 taken along line III-III in FIG. 2. FIG. 3 shows the state of a cross section of a central portion of the developing device 14 in the longitudinal direction.

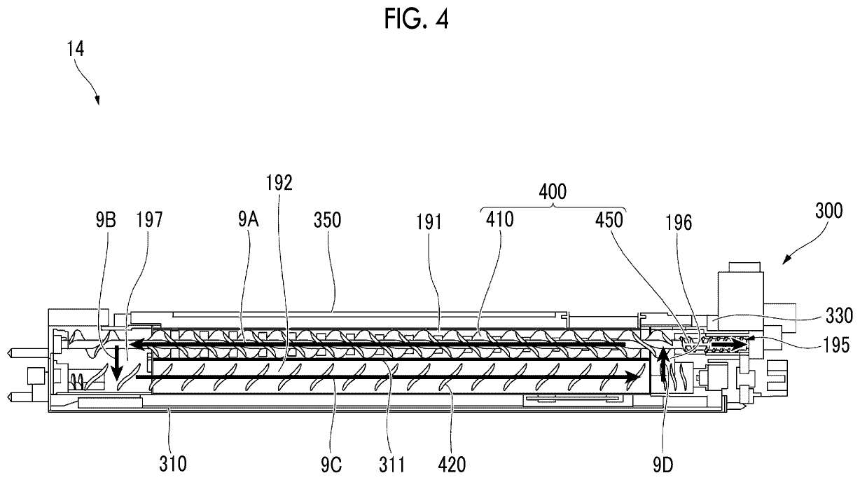

FIG. 4 is a cross-sectional view of the developing device 14 taken along line IV-IV in FIG. 2. FIG. 4 shows the state of a cross section of the developing device 14 in a longitudinal direction.

Note that in the following description, the longitudinal direction of the developing device 14 may be simply referred to as the longitudinal direction. The longitudinal direction of the developing device 14 is an example of one direction.

The developing device 14 is provided with a first transport path 191 through which a developer passes in a case where the developer is to be moved from one end to the other end in the longitudinal direction.

In addition, the developing device 14 is provided with a second transport path 192 through which the developer passes in a case where the developer is to be moved from the other end to the one end in the longitudinal direction. The second transport path 192 is disposed below the first transport path 191.

In addition, the developing device 14 is provided with a discharge path 195 that extends in the longitudinal direction from one end of the first transport path 191 and through which the developer passes in a case where the developer that flows out from the first transport path 191 and that is to be discharged to the outside of the developing device 14 moves.

In addition, the developing device 14 is provided with a first connection portion 196 that connects the one end of the first transport path 191 and one end of the second transport path 192 to each other and through which the developer passes in a case where the developer is to be moved from the one end of the second transport path 192 to the one end of the first transport path 191.

In addition, the developing device 14 is provided with a second connection portion 197 that connects the other end of the first transport path 191 and the other end of the second transport path 192 to each other and through which the developer passes in a case where the developer moves from the other end of the first transport path 191 to the other end of the second transport path 192.

In the first transport path 191, the developer moves in a direction perpendicular to the paper surface of FIG. 3 and in a direction to the rear side of the paper surface. In addition, in the second transport path 192, the developer moves in a direction perpendicular to the paper surface of FIG. 3 and in a direction to the front side of the paper surface. In addition, in the discharge path 195, the developer moves in the direction perpendicular to the paper surface of FIG. 3 and in the direction to the front side of the paper surface.

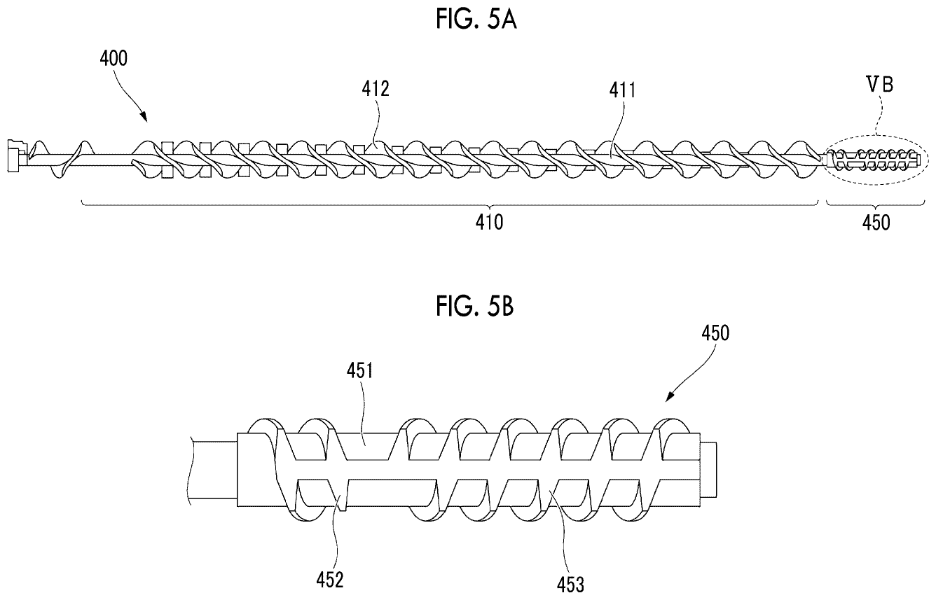

The first transport path 191 is provided with the transport member 400 that transports the developer. Additionally, the first transport path 191 is provided with a first transport member 410 that is a portion of the transport member 400 and that is positioned on the other end side in the one direction. In the present exemplary embodiment, the developer moves from the one end to the other end in the longitudinal direction as the first transport member 410 of the transport member 400 rotates about a rotary shaft 411 (refer to FIGS. 5A and 5B which will be described later) that extends along the first transport path 191.

More specifically, in the present exemplary embodiment, the developer moves in the first transport path 191 from the one end to the other end in the longitudinal direction as the first transport member 410 of the transport member 400 receives a drive force transmitted from the above-described drive force receiving portion 143 (refer to FIG. 2) and the first transport member 410 rotates.

In the present exemplary embodiment, the first transport member 410 transports the developer in the first transport path 191 from the one end to the other end in the longitudinal direction.

The developer moved from the one end to the other end of the first transport path 191 passes through the second connection portion 197 in a direction from an upper side to a lower side and moves to the other end of the second transport path 192.

The second transport path 192 is provided with the second transport member 420 that transports the developer. The second transport member 420 is disposed below the first transport member 410.

In the present exemplary embodiment, the developer moves in the second transport path 192 from the other end to the one end in the longitudinal direction as the second transport member 420 rotates about a rotary shaft 421 that extends along the second transport path 192.

More specifically, the developer moves in the second transport path 192 from the other end to the one end in the longitudinal direction as the second transport member 420 receives a drive force transmitted from the above-described drive force receiving portion 143 and the second transport member 420 rotates.

In the present exemplary embodiment, the second transport member 420 transports the developer from the other end to the one end in the longitudinal direction.

The developer moved from the other end to the one end of the second transport path 192 passes through the first connection portion 196 in a direction from the lower side to the upper side and moves to the one end of the first transport path 191.

A portion of the developer moved to the one end of the first transport path 191 is transported to the other end of the first transport path 191 by the first transport member 410, and the remainder thereof flows out to the discharge path 195.

The discharge path 195 is provided with the transport member 400. Additionally, the discharge path 195 is provided with a discharge transport member 450 that is a portion of the transport member 400 and that is positioned on the one end side in the one direction. In the present exemplary embodiment, the developer moves from the other end to the one end in the longitudinal direction as the discharge transport member 450 of the transport member 400 rotates about a rotary shaft 451 that extends along the discharge path 195.

More specifically, the developer moves in the discharge path 195 from the other end to the one end in the longitudinal direction as the discharge transport member 450 of the transport member 400 receives a drive force transmitted from the above-described drive force receiving portion 143 and the discharge transport member 450 rotates. Accordingly, the developer flowing out from the first transport path 191 to the discharge path 195 is discharged to the outside of the developing device 14.

FIGS. 5A and 5B are views for description of an example of a configuration of the transport member 400. FIG. 5A is a cross-sectional view of the transport member 400 taken along the longitudinal direction of the rotary shaft 411 and the rotary shaft 451. FIG. 5B is an enlarged view of a portion VB in FIG. 5A.

Regarding the transport member 400, as described above, the first transport member 410 and the discharge transport member 450 are integrally formed with each other. Regarding the transport member 400, the first transport member 410 is formed on the other end side in the longitudinal direction and the discharge transport member 450 is formed on the one end side in the longitudinal direction. Additionally, regarding the transport member 400, the discharge transport member 450 is formed to continue from one end of the first transport member 410 in the longitudinal direction.

The first transport member 410 includes the rotary shaft 411 that extends along the longitudinal direction and a blade portion 412 that is provided in a spiral shape around the rotary shaft 411. In the following description, a direction in which the blade portion 412 is wound around the rotary shaft 411 may be referred to as a first winding direction.

In a case where the first transport member 410 rotates about the rotary shaft 411, the developer is transported from the one end to the other end in the longitudinal direction with the blade portion 412 rotating.

The discharge transport member 450 includes the rotary shaft 451 that extends along the longitudinal direction from one end of the rotary shaft 411 of the first transport member 410. In addition, the discharge transport member 450 includes an upstream blade portion 452 and a downstream blade portion 453 that are provided in spiral shapes around the rotary shaft 451. The upstream blade portion 452 is formed at the rotary shaft 451 on the other end side in the longitudinal direction. In addition, the downstream blade portion 453 is formed at the rotary shaft 451 on the one end side in the longitudinal direction.

The upstream blade portion 452 and the downstream blade portion 453 are wound around the rotary shaft 451 in opposite directions. Additionally, a direction in which the upstream blade portion 452 is wound around the rotary shaft 451 is the first winding direction which is the same as a direction in which the blade portion 412 of the first transport member 410 is wound around the rotary shaft 411. In addition, a direction in which the downstream blade portion 453 is wound around the rotary shaft 451 is a second winding direction which is opposite to the direction in which the blade portion 412 of the first transport member 410 is wound around the rotary shaft 411.

In a case where the discharge transport member 450 rotates about the rotary shaft 451, the developer is transported from the one end to the other end in the longitudinal direction with the upstream blade portion 452 rotating. In addition, in a case where the discharge transport member 450 rotates about the rotary shaft 451, the developer is transported from the other end to the one end in the longitudinal direction with the downstream blade portion 453 rotating.

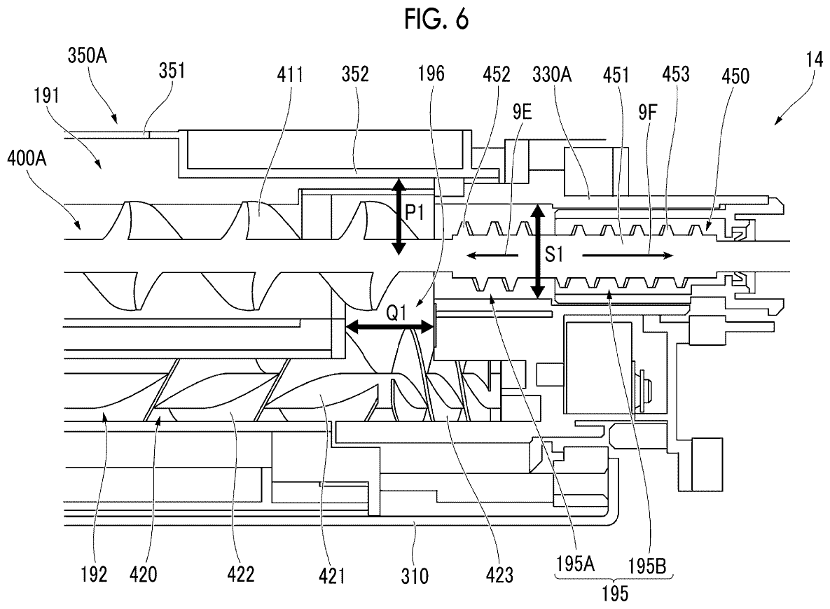

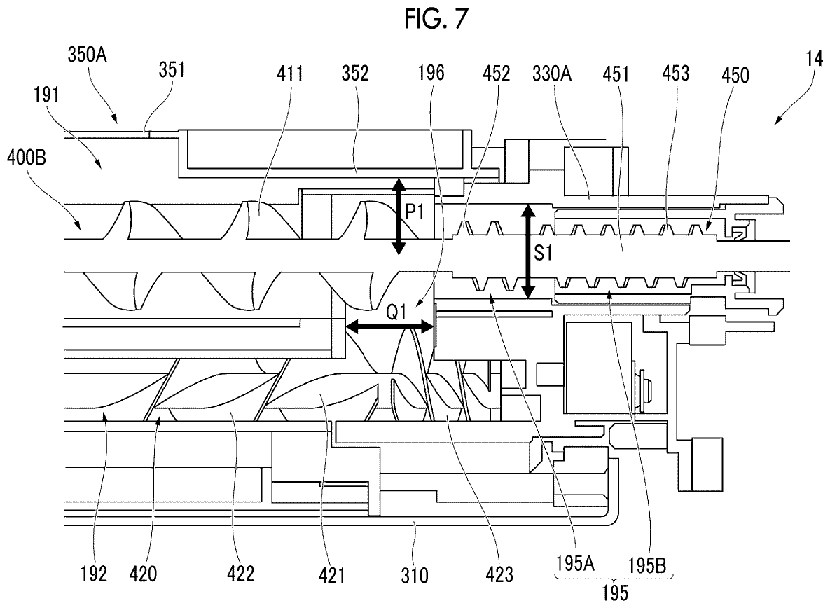

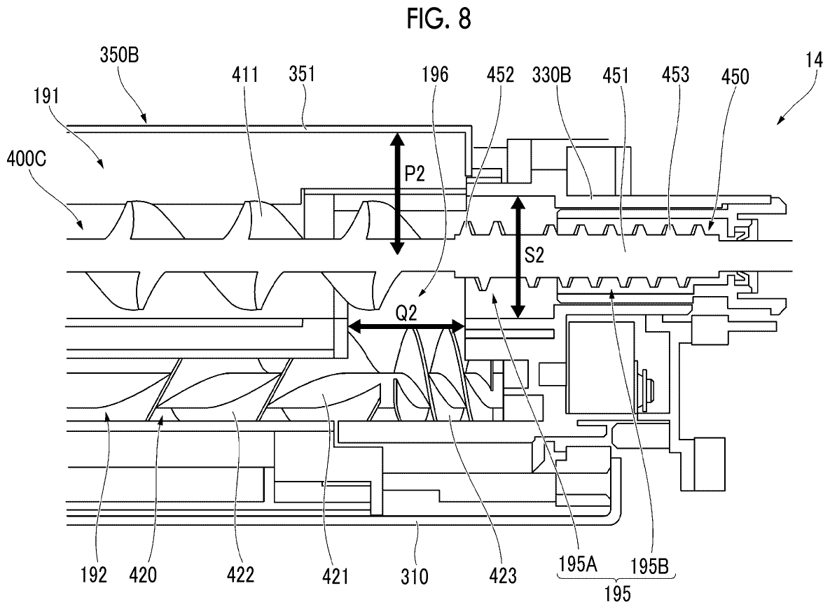

Here, there are a plurality of types of transport members 400 that are different from each other in shape of the discharge transport member 450. In this example, regarding the shape of the discharge transport member 450, there are three types of transport members 400, which are a transport member 400A (refer to FIG. 6 which will be described later), a transport member 400B (refer to FIG. 7 which will be described later), and a transport member 400C (refer to FIG. 8 which will be described later) that are different from each other in number of turns of the upstream blade portion 452 and the downstream blade portion 453.

Although details will be described later, the transport member 400A is combined with the developing device 14 of each basic color image forming unit 200A (refer to FIG. 1). In addition, the transport member 400B is combined with the developing device 14 of the special color image forming unit 200B (refer to FIG. 1). In addition, the transport member 400C is combined with the developing device 14 of the metallic color image forming unit 200C (refer to FIG. 1).

Referring again to FIG. 3, the facing member 430 that is disposed at a position facing the photoreceptor drum 11, which is an example of an image holding body, is provided to the left of the first transport member 410.

The facing member 430 supplies, to the photoreceptor drum 11, a developer supplied from the first transport member 410. The developer is supplied from the first transport member 410 to the facing member 430 and the facing member 430 supplies the developer to the photoreceptor drum 11.

The facing member 430 is composed of a cylindrical body. The facing member 430 is formed of, for example, a metal such as SUS.

The facing member 430 receives a drive force transmitted from the drive force receiving portion 143, rotates in a counterclockwise direction in FIG. 3 around an axis 431, and moves, to the photoreceptor drum 11, a developer that is supplied from the first transport member 410 and that adheres to an outer peripheral surface of the facing member 430.

Accordingly, the developer is supplied to the photoreceptor drum 11, and toner contained in the developer adheres to a surface of the photoreceptor drum 11.

Furthermore, in the present exemplary embodiment, the lower-side transport member 440 that is disposed below the facing member 430 is provided.

The lower-side transport member 440 is disposed closer to the photoreceptor drum 11 than the second transport member 420 is.

The lower-side transport member 440 and the second transport member 420 are disposed along the longitudinal direction and are disposed in a state where the positions thereof are offset from each other in a horizontal direction.

The lower-side transport member 440 is rotated by a drive force transmitted from the drive force receiving portion 143, so that the lower-side transport member 440 transports a developer separated from the facing member 430 in the direction perpendicular to the paper surface of FIG. 3 and in the direction to the rear side of the paper surface.

The lower-side transport member 440 transports the developer separated from the facing member 430 from the one end to the other end in the longitudinal direction, so that the developer is supplied to the other end portion side of the second transport member 420.

The lower-side transport member 440 is provided on a lower-side movement path 193 that is disposed closer to the photoreceptor drum 11 than the second transport path 192 is.

The lower-side movement path 193 is disposed to extend in the direction perpendicular to the paper surface of FIG. 3 and is disposed below the facing member 430. In the present exemplary embodiment, the developer separated from the facing member 430 moves along the lower-side movement path 193.

Furthermore, in the present exemplary embodiment, a magnet roll 145B is provided inside the facing member 430.

The magnet roll 145B is provided with five magnetic poles 121 to 125 arranged in a circumferential direction of the magnet roll 145B.

The magnetic pole 121 is a pickup pole and attracts a developer supplied from the first transport path 191. Accordingly, the developer adheres to a surface of the facing member 430.

The magnetic poles 122 to 124 have a role as transport poles and move the developer on the surface of the facing member 430 to a downstream side in a rotation direction of the facing member 430.

In a case where the developer on the surface of the facing member 430 moves to the downstream side in the rotation direction of the facing member 430, the developer moves to the surface of the photoreceptor drum 11 which is an example of an image holding body and toner contained in the developer adheres to the photoreceptor drum 11.

Accordingly, development is performed, and an image consisting of the toner is formed on the surface of the photoreceptor drum 11.

The image is temporarily held by the photoreceptor drum 11 and is moved to the primary transfer unit 10 (refer to FIG. 1) with the photoreceptor drum 11 rotating. Then, the image is transferred to the intermediate transfer belt 15.

The magnetic pole 125 has a role as a pick-off pole, forms a repulsive magnetic field, and causes the developer adhering to the surface of the facing member 430 to be separated from the facing member 430. The magnetic pole 125 causes the developer that remains on the surface of the facing member 430 without being transferred to the photoreceptor drum 11 to be separated from the facing member 430.

In the present exemplary embodiment, separation of the developer occurs at a separation point 296.

In the present exemplary embodiment, the separation point 296 is positioned ahead of the magnetic pole 121 having a role as a pickup pole, and the developer is separated ahead of the magnetic pole 121 in the present exemplary embodiment.

The developer separated from the facing member 430 moves downward and reaches the lower-side movement path 193.

The developer that has reached the lower-side movement path 193 is moved toward the other end portion 142 (refer to FIG. 2) of the developing device 14 by the lower-side transport member 440, and then is moved to the second transport path 192 (refer to FIG. 3).

The developing device 14 is provided with an accommodation portion 300 that accommodates the first transport member 410, the second transport member 420, the facing member 430, and the lower-side transport member 440 and that constitutes an accommodation portion accommodating a developer.

A portion of the accommodation portion 300 that faces the photoreceptor drum 11 is provided with an opening 301 that extends in the longitudinal direction. Additionally, in the developing device 14 of the present exemplary embodiment, the facing member 430 faces the photoreceptor drum 11 through the opening 301.

The accommodation portion 300 includes a body portion 310, an attachment portion 330 that is attached to one end of the body portion 310 in the longitudinal direction, and a cover portion 350 that covers the body portion 310 and the attachment portion 330 from above. Each of the attachment portion 330 and the cover portion 350 is an example of a plurality of components forming an accommodation portion and a discharge path. In addition, the attachment portion 330 is an example of a first component, and the cover portion 350 is an example of a second component.

Inside the body portion 310, the first transport path 191, the second transport path 192, the lower-side movement path 193, and the second connection portion 197 described above are formed. Additionally, the body portion 310 is provided with a partition wall 311 that partitions a space inside the body portion 310 into the first transport path 191 and the second transport path 192. In addition, the body portion 310 accommodates the first transport member 410 of the transport member 400, the second transport member 420, the facing member 430, and the lower-side transport member 440 described above.

Inside the attachment portion 330, the first connection portion 196 and the discharge path 195 described above are formed. In addition, inside the attachment portion 330, an end portion of the above-described first transport path 191 that is on the one end side and an end portion of the above-described second transport path 192 that is on the one end side are formed.

Furthermore, the attachment portion 330 accommodates a portion of the first transport member 410 of the above-described transport member 400 that is on the one end side and the above-described discharge transport member 450. In addition, the attachment portion 330 accommodates a portion of the second transport member 420 that is on the one end side.

In the developing device 14 of the present exemplary embodiment, there are a plurality of types of attachment portions 330 that are different from each other in shape. Additionally, there are a plurality of types of attachment portions 330 that are different from each other in shape of the first connection portion 196 and the discharge path 195.

In this example, there are two types of attachment portions 330, which are an attachment portion 330A (refer to FIG. 6 which will be described later) and an attachment portion 330B (refer to FIG. 8 which will be described later) that are different from each other in shape of the first connection portion 196 and the discharge path 195. Although details will be described later, the attachment portion 330A is combined with the accommodation portion 300 of the developing device 14 of each of the basic color image forming units 200A (refer to FIG. 1) and the special color image forming unit 200B (refer to FIG. 1). In addition, the attachment portion 330B is combined with the accommodation portion 300 of the developing device 14 of the metallic color image forming unit 200C (refer to FIG. 1).

The cover portion 350 covers the first transport path 191 from above, the first transport path 191 being formed inside the body portion 310 and the attachment portion 330. The cover portion 350 is provided to face the first transport member 410 of the transport member 400 with a gap formed therebetween.

Regarding the developing device 14 of the present exemplary embodiment, there are a plurality of types of cover portions 350 that are different from each other in shape. Additionally, there are a plurality of types of cover portions 350 that are different from each other in distance to the first transport member 410.

In this example, there are two types of cover portions 350, which are a cover portion 350A (refer to FIG. 6) and a cover portion 350B (refer to FIG. 8) that are different from each other in distance to the first transport member 410. Although details will be described later, the cover portion 350A is combined with the accommodation portion 300 of the developing device 14 of each of the basic color image forming units 200A and the special color image forming unit 200B. In addition, the cover portion 350B is combined with the accommodation portion 300 of the developing device 14 of the metallic color image forming unit 200C.

Note that in the present exemplary embodiment, the body portion 310 combined with the accommodation portion 300 is common to all of the developing devices 14 of the basic color image forming units 200A, the developing device 14 of the special color image forming unit 200B, and the developing device 14 of the metallic color image forming unit 200C.

FIG. 6 is a view for description of a configuration of the developing device 14 on the one end side in the longitudinal direction. FIG. 6 shows the state of a cross section of the developing device 14 taken along the longitudinal direction on the one end side in the longitudinal direction.

Note that FIG. 6 shows the developing device 14 of the basic color image forming unit 200A (refer to FIG. 1). The transport member 400A, which is one of the plurality of types of transport members 400, is combined with the developing device 14 of the basic color image forming unit 200A. In addition, the attachment portion 330A, which is one of the plurality of types of attachment portions 330, is combined with the developing device 14 of the basic color image forming unit 200A and the cover portion 350A, which is one of the plurality of types of cover portions 350, is combined with the developing device 14 of the basic color image forming unit 200A.

In the attachment portion 330A, an end portion of the first transport path 191 that is on the one end side in the longitudinal direction and an end portion of the second transport path 192 that is on the one end side in the longitudinal direction are formed. Additionally, the first transport path 191 is formed over the body portion 310 and the attachment portion 330A and the end portion of the first transport path 191 that is on the one end side in the longitudinal direction is positioned in the attachment portion 330A. Similarly, the second transport path 192 is formed over the body portion 310 and the attachment portion 330A, and an end portion of the second transport path 192 that is on the one end side in the longitudinal direction is positioned in the attachment portion 330A.

In addition, in the attachment portion 330A, the first connection portion 196 connecting the end portion of the first transport path 191 that is on the one end side in the longitudinal direction and the end portion of the second transport path 192 that is on the one end side in the longitudinal direction to each other is formed.

The attachment portion 330A accommodates a portion of the first transport member 410 that is on the one end side in the longitudinal direction, the first transport member 410 being disposed in the first transport path 191.

Additionally, the attachment portion 330A accommodates portions of the rotary shaft 411 and the blade portion 412 of the first transport member 410 that are on the one end side in the longitudinal direction.

The attachment portion 330A accommodates a portion of the second transport member 420 that is on the one end side in the longitudinal direction, the second transport member 420 being disposed in the second transport path 192.

The second transport member 420 includes the rotary shaft 421 that extends along the longitudinal direction and a blade portion 422 that is provided in a spiral shape around the rotary shaft 421. In addition, the second transport member 420 includes a blade portion 423 that is provided in a spiral shape around the rotary shaft 421 while being closer to the one end side in the longitudinal direction than the blade portion 422 is.

A direction in which the blade portion 422 is wound around the rotary shaft 421 is the second winding direction. In addition, a direction in which the blade portion 423 is wound around the rotary shaft 421 is the first winding direction.

In the present exemplary embodiment, the second transport member 420 is disposed such that a boundary portion between the blade portion 422 and the blade portion 423 is positioned below the first connection portion 196.

In a case where the second transport member 420 rotates about the rotary shaft 421, a developer is transported from the other end of the second transport path 192 to the one end of the second transport path 192 in the longitudinal direction with the blade portion 422 rotating. In addition, with the blade portion 423 rotating, the developer transported to the one end of the second transport path 192 in the longitudinal direction is transported to a portion of the second transport path 192 that faces the first connection portion 196.

In addition, in the attachment portion 330A, the discharge path 195 is formed.

As shown in FIG. 6, the discharge path 195 includes an upstream discharge path 195A that continues from the one end of the first transport path 191 and that extends in the longitudinal direction. In addition, the discharge path 195 includes a downstream discharge path 195B that continues from one end of the upstream discharge path 195A and that extends in the longitudinal direction. In addition, although not shown, an end portion of the downstream discharge path 195B that is on the one end side is connected to the outside of the developing device 14.

The upstream discharge path 195A and the downstream discharge path 195B are columnar spaces of which central axes are parallel to the rotary shaft 451 of the discharge transport member 450. In this example, a diameter S1 of the upstream discharge path 195A is larger than the diameter of the downstream discharge path 195B.

The upstream blade portion 452 of the discharge transport member 450 is disposed in the upstream discharge path 195A. The upstream blade portion 452 of the discharge transport member 450 is an example of an upstream transport portion.

In addition, the downstream blade portion 453 of the discharge transport member 450 is disposed in the downstream discharge path 195B. The downstream blade portion 453 of the discharge transport member 450 is an example of a downstream transport portion.

The cover portion 350A covers the first transport path 191 from above, the first transport path 191 being formed inside the body portion 310 and the attachment portion 330. In addition, the cover portion 350A is provided to face the first transport member 410 that is accommodated over the body portion 310 and the attachment portion 330A.

In the present exemplary embodiment, the cover portion 350A includes an upper wall portion 351 that faces the first transport member 410 at a predetermined distance. In addition, the cover portion 350A includes a recess portion 352 that is provided on the one end side in the longitudinal direction with respect to the upper wall portion 351 and that is recessed to be closer to the lower side than the upper wall portion 351 is. In this example, each of the upper wall portion 351 and the recess portion 352 has a flat plate-like shape extending in a direction perpendicular to the paper surface of FIG. 6.

The recess portion 352 faces an end portion of the first transport member 410 that is on the one end side. In addition, the recess portion 352 faces the first connection portion 196 formed in the attachment portion 330A, with the first transport member 410 interposed therebetween.

In the present exemplary embodiment, the cover portion 350A includes the recess portion 352, and thus a ceiling height P1 of the one end of the first transport path 191 in the longitudinal direction that is connected to the first connection portion 196 is small in comparison with the other end side in the longitudinal direction. In the present exemplary embodiment, the ceiling height of the first transport path 191 is a distance from the center of the rotary shaft 411 of the first transport member 410 disposed in the first transport path 191 to the upper wall portion 351 or the recess portion 352 of the cover portion 350A.

Next, the behavior of a developer in the developing device 14 will be described with reference to FIGS. 4 to 6.

The developing device 14 of the present exemplary embodiment is provided with an annular movement path for the developer, the movement path being composed of the first transport path 191, the second transport path 192, the first connection portion 196, and the second connection portion 197. In addition, the developing device 14 of the present exemplary embodiment is provided with a movement path for the developer to be discharged to the outside of the developing device 14, the movement path being composed of the discharge path 195 connected to the one end of the first transport path 191.

In the first transport path 191, the second connection portion 197, the second transport path 192, and the first connection portion 196, the developer moves in directions along an arrow 9A, an arrow 9B, an arrow 9C, and an arrow 9D shown in FIG. 4, respectively.

In the first transport path 191, as represented by the arrow 9A in FIG. 4, the developer is moved through the first transport path 191 from the one end to the other end in the longitudinal direction by being transported by the first transport member 410 of the transport member 400 and is moved to a side on which the second connection portion 197 is provided.

Then, as represented by the arrow 9B, the developer moves through the second connection portion 197 in the direction from the upper side to the lower side and moves to the other end of the second transport path 192.

In the second transport path 192, as represented by the arrow 9C, the developer is moved through the second transport path 192 from the other end to the one end in the longitudinal direction by being transported by the second transport member 420 and is moved to a side on which the first connection portion 196 is provided.

Thereafter, as represented by the arrow 9D, the developer moves through the first connection portion 196 in the direction from the lower side to the upper side and moves to the one end of the first transport path 191.

In addition, a portion of the developer moved to the one end of the first transport path 191 flows out to the discharge path 195 connected to the one end of the first transport path 191. Additionally, in a case where the level of the developer accommodated in the accommodation portion 300 exceeds a predetermined height, a surplus of the developer flows out from the first transport path 191 to the upstream discharge path 195A of the discharge path 195. Note that “the level of the developer” is the height of the surface of the developer accommodated and transported in the accommodation portion 300.

As represented by an arrow 9E in FIG. 6, a portion of the developer flowing out to the upstream discharge path 195A is caused to return to the first transport path 191 from the upstream discharge path 195A by being transported by the upstream blade portion 452 of the discharge transport member 450.

In addition, the remainder of the developer flowing out to the upstream discharge path 195A moves through the upstream discharge path 195A from the one end to the other end in the longitudinal direction and moves to the downstream discharge path 195B.

As represented by an arrow 9F in FIG. 6, the developer moved to the downstream discharge path 195B is discharged to the outside of the accommodation portion 300 by being transported by the downstream blade portion 453 of the discharge transport member 450.

Here, in the image forming apparatus 100, from the viewpoint of suppressing defects or the like of toner images formed on the photoreceptor drums 11, for example, it is preferable that the level of the developer accommodated in the developing device 14 of each image forming unit 200 is equal to a predetermined height. In other words, in the image forming apparatus 100, for example, it is preferable that there is no difference between the level of the developers accommodated in the developing devices 14 of the plurality of image forming units 200 and the predetermined height.

As described above, in the present exemplary embodiment, the basic color image forming units 200A, the special color image forming unit 200B, and the metallic color image forming unit 200C are different from each other in fluidity of a developer used therein. Therefore, in a case where the plurality of image forming units 200 are uniform with each other in structure for discharge of a surplus of a developer in the developing device 14 to the outside of the accommodation portion 300, the amount of discharge of the developers may be insufficient or excessive due to a difference in fluidity between the developers. For example, the lower the fluidity of a developer is, the more difficult it is for the developer to move in the accommodation portion 300. Therefore, the lower the fluidity of a developer is, the more likely the amount of discharge of the developer is to become insufficient and the more likely the level of the developer accommodated in the developing device 14 is to become high. In addition, the higher the fluidity of a developer is, the more easily the developer moves in the accommodation portion 300. Therefore, the higher the fluidity of a developer is, the more likely the amount of discharge of the developer is to become excessive and the more likely the level of the developer accommodated in the developing device 14 is to become low. In this case, the amounts of developers accommodated in the developing devices 14 of the plurality of image forming units 200 are likely to be unstable.

However, in the image forming apparatus 100 of the present exemplary embodiment, the basic color image forming units 200A, the special color image forming unit 200B, and the metallic color image forming unit 200C, which are different from each other in fluidity of a developer, are different from each other in structure for discharge of a surplus of a developer in the developing device 14 to the outside of the accommodation portion 300.

FIG. 7 is a view for description of a configuration of the developing device 14 of the special color image forming unit 200B (refer to FIG. 1).

FIG. 8 is a view for description of a configuration of the developing device 14 of the metallic color image forming unit 200C (refer to FIG. 1).

As with FIG. 6, each of FIGS. 7 and 8 shows the state of a cross section of the developing device 14 taken along the longitudinal direction on the one end side in the longitudinal direction.

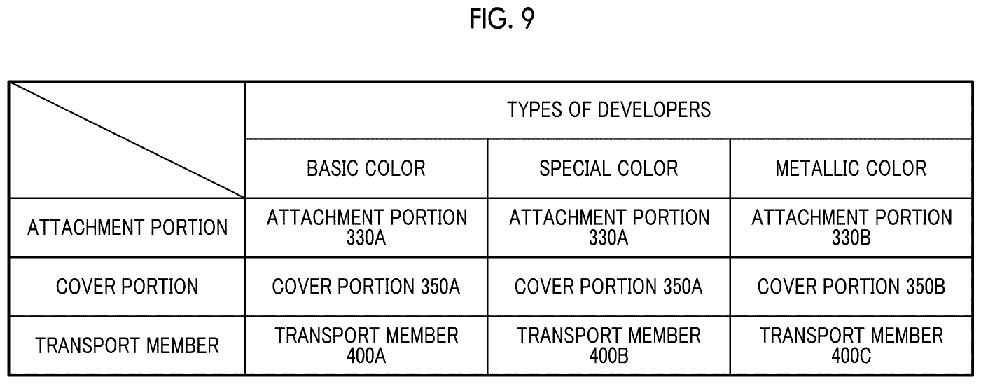

FIG. 9 is a table showing the types of the attachment portions 330, the cover portions 350, and the transport members 400 to be combined with the developing devices 14.

In the present exemplary embodiment, the lower the fluidity of a developer to be accommodated in the accommodation portion 300 of the developing device 14 is, the more the developing device 14 is shaped to facilitate discharge of the developer to the outside of the accommodation portion 300 via the discharge path 195. Additionally, the attachment portion 330, the cover portion 350, and the transport member 400 are combined with the developing device 14 of the present exemplary embodiment such that the lower the fluidity of a developer to be accommodated in the accommodation portion 300 is, the more likely the developer is to be discharged to the outside of the accommodation portion 300 via the discharge path 195.

Specifically, as shown in FIG. 9, each of the developing devices 14 of the basic color image forming units 200A that accommodate the developers of the basic colors is combined with the attachment portion 330A, the cover portion 350A, and the transport member 400A.

In addition, the developing device 14 of the special color image forming unit 200B that accommodates the developer of the special color of which the fluidity is lower than the fluidity of the developers of the basic colors is combined with the attachment portion 330A, the cover portion 350A, and the transport member 400B.

In addition, the developing device 14 of the metallic color image forming unit 200C that accommodates the developer of the metallic color of which the fluidity is lower than the fluidity of the developers of the basic colors and the fluidity of the developer of the special color is combined with the attachment portion 330B, the cover portion 350B, and the transport member 400C.

Here, in each developing device 14, a developer that flows out from the one end of the first transport path 191 to the upstream discharge path 195A of the discharge path 195 after moving from the first connection portion 196 to the one end of the first transport path 191 and that moves to the downstream discharge path 195B from the upstream discharge path 195A is discharged to the outside of the accommodation portion 300.

In addition, in the developing device 14, the wider a movement path for the developer over the first connection portion 196, the first transport path 191, the upstream discharge path 195A of the discharge path 195, and the downstream discharge path 195B is, the more likely the developer is to be discharged to the outside of the accommodation portion 300.

More specifically, in the developing device 14, the higher the ceiling height of the first transport path 191 connected to the first connection portion 196 is, the more likely the developer is to be discharged to the outside of the accommodation portion 300.

In addition, in the developing device 14, the larger the width of the first connection portion 196 is, the more likely the developer is to be discharged to the outside of the accommodation portion 300. In this example, the width of the first connection portion 196 means the width of the first connection portion 196 in the longitudinal direction.

In addition, in the developing device 14, the larger the diameter of the upstream discharge path 195A of the discharge path 195 is, the more likely the developer is to be discharged to the outside of the accommodation portion 300.

In the developing device 14 of the present exemplary embodiment, the lower the fluidity of a developer to be accommodated is, the wider a movement path for the developer over the first connection portion 196, the first transport path 191, the upstream discharge path 195A of the discharge path 195, and the downstream discharge path 195B is.

Specifically, as shown in FIG. 6, in the developing device 14 of the basic color image forming unit 200A, the width of the first connection portion 196 is Q1. In addition, in the developing device 14 of the basic color image forming unit 200A, since the cover portion 350A includes the recess portion 352, the ceiling height of the first transport path 191 is P1. In addition, in the developing device 14 of the basic color image forming unit 200A, the diameter of the upstream discharge path 195A is S1.

In addition, as shown in FIG. 7, in the developing device 14 of the special color image forming unit 200B, the width of the first connection portion 196 is Q1 as in the basic color image forming unit 200A. In addition, in the developing device 14 of the special color image forming unit 200B, the ceiling height of the first transport path 191 is PI as in the basic color image forming unit 200A. In addition, in the developing device 14 of the special color image forming unit 200B, the diameter of the upstream discharge path 195A is S1 as in the basic color image forming unit 200A.

However, in the developing device 14 of the metallic color image forming unit 200C in which the developer of the metallic color of which the fluidity is lower than the fluidities of the developers of the basic colors and the special color is accommodated, the width of the first connection portion 196 is wide in comparison with the basic color image forming unit 200A and the special color image forming unit 200B. That is, in the developing device 14 of the metallic color image forming unit 200C, the width of the first connection portion 196 is Q2, which is larger than a width Q1 in the basic color image forming unit 200A and the special color image forming unit 200B.

In addition, in the developing device 14 of the metallic color image forming unit 200C, the ceiling height of the first transport path 191 is high in comparison with the basic color image forming unit 200A and the special color image forming unit 200B. Specifically, as shown in FIG. 8, the cover portion 350B does not include the recess portion 352 (refer to FIG. 6) unlike the cover portion 350A (refer to FIG. 6). Therefore, in the developing device 14 of the metallic color image forming unit 200C, the ceiling height of the first transport path 191 is P2, which is larger than the ceiling height P1 in the basic color image forming unit 200A and the special color image forming unit 200B.

Furthermore, in the developing device 14 of the metallic color image forming unit 200C, the diameter of the upstream discharge path 195A is large in comparison with the basic color image forming unit 200A and the special color image forming unit 200B. That is, in the developing device 14 of the metallic color image forming unit 200C, the diameter of the upstream discharge path 195A is S2, which is larger than the diameter S1 in the basic color image forming unit 200A and the special color image forming unit 200B.

In addition, in each developing device 14, the smaller the amount of a developer that is a portion of a developer flowing out to the upstream discharge path 195A from the first transport path 191 and that is caused to return to the first transport path 191 by the upstream blade portion 452 of the discharge transport member 450 is, the more likely the developer is to be discharged to the outside of the accommodation portion 300.

In other words, in the developing device 14, the smaller a developer transport force generated by the upstream blade portion 452 of the discharge transport member 450 is, the more likely the developer is to be discharged to the outside of the accommodation portion 300.

In the developing device 14 of the present exemplary embodiment, the lower the fluidity of a developer to be accommodated is, the smaller the number of turns of the upstream blade portion 452 is. Accordingly, regarding the developing device 14, the lower the fluidity of a developer to be accommodated is, the smaller a developer transport force generated by the upstream blade portion 452 of the discharge transport member 450 is.

Specifically, as shown in FIG. 6, in the developing device 14 of the basic color image forming unit 200A, the number of turns of the upstream blade portion 452 with respect to the rotary shaft 451 of the discharge transport member 450 is three.

In addition, as shown in FIG. 7, in the developing device 14 of the special color image forming unit 200B in which the developer of the special color of which the fluidity is lower than the fluidities of the developers of the basic colors is accommodated, the number of turns of the upstream blade portion 452 with respect to the rotary shaft 451 of the discharge transport member 450 is 2.5.

Furthermore, as shown in FIG. 8, in the developing device 14 of the metallic color image forming unit 200C in which the developer of the metallic color of which the fluidity is lower than the fluidities of the developers of the basic colors and the special color is accommodated, the number of turns of the upstream blade portion 452 with respect to the rotary shaft 451 of the discharge transport member 450 is two.

Note that a developer transport force generated by the upstream blade portion 452 of the discharge transport member 450 depends on the protrusion height of the upstream blade portion 452 from the rotary shaft 451, the pitch of the upstream blade portion 452, or the like in addition to the number of turns of the upstream blade portion 452. Regarding the developing device 14, the values of the protrusion height, the pitch, or the like may be adjusted such that the lower the fluidity of a developer to be accommodated is, the smaller a developer transport force generated by the upstream blade portion 452 of the discharge transport member 450 is.

As described above, in the image forming apparatus 100 of the present exemplary embodiment, the lower the fluidity of a developer to be accommodated in the accommodation portion 300 of the developing device 14 is, the more the developing device 14 is shaped to facilitate discharge of the developer to the outside of the accommodation portion 300.

Specifically, in the image forming apparatus 100 of the present exemplary embodiment, the developing devices 14 are shaped such that the likelihood of discharge of a developer to the outside of the accommodation portion 300 increases in the order of the basic color image forming units 200A, the special color image forming unit 200B, and the metallic color image forming unit 200C. In other words, in the image forming apparatus 100, the developing device 14 of the metallic color image forming unit 200C has a shape in which the developer is most likely to be discharged to the outside of the accommodation portion 300. In addition, in the image forming apparatus 100, the developing device 14 of the basic color image forming unit 200A has a shape in which the developer is most unlikely to be discharged to the outside of the accommodation portion 300.

Accordingly, in the image forming apparatus 100 of the present exemplary embodiment, the amount of discharge of developers being insufficient or excessive due to a difference in fluidity between the developers is suppressed in the basic color image forming units 200A, the special color image forming unit 200B, and the metallic color image forming unit 200C.

Accordingly, the amount of a developer accommodated in the accommodation portion 300 of each developing device 14 may be stabilized in comparison with a case where the shapes of the developing devices 14 of the basic color image forming units 200A, the special color image forming unit 200B, and the metallic color image forming unit 200C are uniform with each other.

Meanwhile, examples of means for changing the likelihood of discharge of a developer to the outside of the accommodation portion 300 in accordance with the fluidity of the developer include a method of changing the shape of the developing device 14 or the entire accommodation portion 300 in accordance with the fluidity of the developer. However, in this case, it is necessary to manufacture the developing device 14 or the accommodation portion 300 for each of the types of developers having different fluidities. Therefore, the manufacturing cost and time required for manufacturing the image forming apparatus 100 are likely to increase.

However, in the image forming apparatus 100 of the present exemplary embodiment, the type of a component to be combined with the developing device 14 is changed in accordance with the fluidity of a developer to change the likelihood of discharge of the developer to the outside of the accommodation portion 300. Accordingly, in the image forming apparatus 100 of the present exemplary embodiment, it is possible to change the likelihood of discharge of a developer to the outside of the accommodation portion 300 in accordance with the fluidity of the developer in a simpler manner. In addition, an increase in manufacturing cost of the image forming apparatus 100 can be suppressed in comparison with a case of changing the shape of the developing device 14 or the entire accommodation portion 300 in accordance with the fluidity of a developer.

Although the exemplary embodiment of the present invention has been described above, a technical scope of the present invention is not limited to the scope described in the above-described exemplary embodiment. According to the claims, it is obvious that the above-described exemplary embodiment to which various modifications or improvements are carried out also falls within the technical scope of the present invention.

### Supplementary Note

(((1)))

An image forming apparatus comprising:
a plurality of image holding bodies; and
a plurality of developing devices that respectively develop images on the image holding bodies by using developers that are different from each other in fluidity,
wherein each of the developing devices includes
   an accommodation portion that accommodates a developer and that includes a first transport path extending in one direction, a second transport path disposed below the first transport path and extending in the one direction, a first connection portion connecting one end of the first transport path and one end of the second transport path to each other, and a second connection portion connecting the other end of the first transport path and the other end of the second transport path to each other,
   a first transport member that is disposed in the first transport path and that transports the developer from one end to the other end in the one direction,
   a second transport member that is disposed in the second transport path and that transports the developer from the other end to the one end in the one direction,
   a discharge path that extends in the one direction from the one end of the first transport path and through which the developer flowing out from the first transport path is discharged to an outside of the accommodation portion, and
   a discharge transport member that is disposed in the discharge path and that transports the developer flowing out from the first transport path, and
the lower a fluidity of the developer to be accommodated in the accommodation portion is, the more the discharge path, the discharge transport member, the first transport path of the accommodation portion, or the first connection portion is shaped to facilitate discharge of the developer to the outside of the accommodation portion.
(((2)))

The image forming apparatus according to (((1))),
wherein, in each of the plurality of developing devices, the lower the fluidity of the developer to be accommodated in the accommodation portion is, the wider a movement path for the developer to be discharged to the outside of the accommodation portion through the first connection portion, the one end of the first transport path, and the discharge path is.
(((3)))

The image forming apparatus according to (((2))),
wherein, in each of the plurality of developing devices, the lower the fluidity of the developer to be accommodated in the accommodation portion is, the larger a ceiling height of the one end of the first transport path connected to the first connection portion is.
(((4)))

The image forming apparatus according to (((2))),
wherein, in each of the plurality of developing devices, the lower the fluidity of the developer to be accommodated in the accommodation portion is, the larger a width of the first connection portion is.
(((5))

The image forming apparatus according to (((2)))
wherein the discharge transport member includes
   an upstream transport portion that continues from one end of the first transport member and that transports the developer flowing out from the first transport path toward the first transport path, and
   a downstream transport portion that continues from one end of the upstream transport portion and that transports the developer flowing out from the first transport path toward the outside of the accommodation portion, the discharge path includes
   an upstream discharge path that continues from the one end of the first transport path and in which the upstream transport portion is disposed, and
   a downstream discharge path that continues from one end of the upstream discharge path and in which the downstream transport portion is disposed, and
in each of the plurality of developing devices, the lower the fluidity of the developer to be accommodated in the accommodation portion is, the larger a diameter of the upstream discharge path is.
(((6))

The image forming apparatus according to any one of (((1))) to (((5))
wherein the discharge transport member includes
   an upstream transport portion that continues from one end of the first transport member and that transports the developer flowing out from the first transport path toward the first transport path, and
   a downstream transport portion that continues from one end of the upstream transport portion and that transports the developer flowing out from the first transport path toward the outside of the accommodation portion, and
in each of the plurality of developing devices, the lower the fluidity of the developer to be accommodated in the accommodation portion is, the smaller a transport force generated by the upstream transport portion is.
(((7)))

The image forming apparatus according to (((6))),
wherein the discharge transport member includes
   a rotary shaft that extends in the one direction,
   an upstream blade portion that is provided in a spiral shape around the rotary shaft and that constitutes the upstream transport portion, and
   a downstream blade portion that is provided in a spiral shape around the rotary shaft and that constitutes the downstream transport portion, and
in each of the plurality of developing devices, the lower the fluidity of the developer to be accommodated in the accommodation portion is, the smaller the number of turns of the upstream blade portion is.
(((8)))

The image forming apparatus according to any one of (((1))) to ((7))),
wherein, in each of the plurality of developing devices, the accommodation portion and the discharge path are formed by a plurality of components, and
the lower the fluidity of the developer is, the more each of the plurality of developing devices is shaped to facilitate discharge of the developer to the outside of the accommodation portion with types of the components to be combined or a type of the discharge transport member to be combined with the plurality of components differing depending on the fluidity of the developer to be accommodated in the accommodation portion.
(((9)))

The image forming apparatus according to (((8))),
wherein the discharge transport member includes
   an upstream transport portion that continues from one end of the first transport member and that transports the developer flowing out from the first transport path toward the first transport path, and
   a downstream transport portion that continues from one end of the upstream transport portion and that transports the developer flowing out from the first transport path toward the outside of the accommodation portion, the discharge path includes
   an upstream discharge path that continues from the one end of the first transport path and in which the upstream transport portion is disposed, and
   a downstream discharge path that continues from one end of the upstream discharge path and in which the downstream transport portion is disposed, and
in each of the plurality of developing devices, a plurality of types of first components that are different from each other in width of the first connection portion or a diameter of the upstream discharge path, a plurality of types of second components that are different from each other in ceiling height of the one end of the first transport path connected to the first connection portion, and a plurality of types of discharge transport members that are different from each other in transport force generated by the upstream transport portion are combined with each other in a different manner depending on the fluidity of the developer to be accommodated in the accommodation portion.
(((10)))

A developing device comprising:
an accommodation portion that accommodates a developer and that includes a first transport path extending in one direction, a second transport path disposed below the first transport path and extending in the one direction, a first connection portion connecting one end of the first transport path and one end of the second transport path to each other, and a second connection portion connecting the other end of the first transport path and the other end of the second transport path to each other;
a first transport member that is disposed in the first transport path and that transports the developer from one end to the other end in the one direction;
a second transport member that is disposed in the second transport path and that transports the developer from the other end to the one end in the one direction;
a discharge path that extends in the one direction from the one end of the first transport path and through which the developer flowing out from the first transport path is discharged to an outside of the accommodation portion; and
a discharge transport member that is disposed in the discharge path and that transports the developer flowing out from the first transport path,
wherein the accommodation portion and the discharge path are formed by a plurality of components, and
likelihood of discharge of the developer to the outside of the accommodation portion is changeable by changing types of the components to be combined or a type of the discharge transport member to be combined with the plurality of components.
(((11))

The developing device according to (((10))),
wherein a ceiling height of the one end of the first transport path connected to the first connection portion, a width of the first connection portion, a diameter of the discharge path, or a transport force generated by the discharge transport member is changeable by changing the types of the components to be combined or the type of the discharge transport member to be combined with the plurality of components.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of image holding bodies; and
a plurality of developing devices that respectively develop images on the image holding bodies by using developers that are different from each other in fluidity,
wherein each of the developing devices includes
an accommodation portion that accommodates a developer and that includes a first transport path extending in one direction, a second transport path disposed below the first transport path and extending in the one direction, a first connection portion connecting one end of the first transport path and one end of the second transport path to each other, and a second connection portion connecting the other end of the first transport path and the other end of the second transport path to each other,
a first transport member that is disposed in the first transport path and that transports the developer from one end to the other end in the one direction,
a second transport member that is disposed in the second transport path and that transports the developer from the other end to the one end in the one direction,
a discharge path that extends in the one direction from the one end of the first transport path and through which the developer flowing out from the first transport path is discharged to an outside of the accommodation portion, and
a discharge transport member that is disposed in the discharge path and that transports the developer flowing out from the first transport path, and
the lower a fluidity of the developer to be accommodated in the accommodation portion is, the more the discharge path, the discharge transport member, the first transport path of the accommodation portion, or the first connection portion is shaped to facilitate discharge of the developer to the outside of the accommodation portion.

2. The image forming apparatus according to claim 1,
wherein, in each of the plurality of developing devices, the lower the fluidity of the developer to be accommodated in the accommodation portion is, the wider a movement path for the developer to be discharged to the outside of the accommodation portion through the first connection portion, the one end of the first transport path, and the discharge path is.

3. The image forming apparatus according to claim 2,
wherein, in each of the plurality of developing devices, the lower the fluidity of the developer to be accommodated in the accommodation portion is, the larger a ceiling height of the one end of the first transport path connected to the first connection portion is.

4. The image forming apparatus according to claim 2,
wherein, in each of the plurality of developing devices, the lower the fluidity of the developer to be accommodated in the accommodation portion is, the larger a width of the first connection portion is.

5. The image forming apparatus according to claim 2,
wherein the discharge transport member includes
an upstream transport portion that continues from one end of the first transport member and that transports the developer flowing out from the first transport path toward the first transport path, and
a downstream transport portion that continues from one end of the upstream transport portion and that transports the developer flowing out from the first transport path toward the outside of the accommodation portion,
the discharge path includes
an upstream discharge path that continues from the one end of the first transport path and in which the upstream transport portion is disposed, and
a downstream discharge path that continues from one end of the upstream discharge path and in which the downstream transport portion is disposed, and
in each of the plurality of developing devices, the lower the fluidity of the developer to be accommodated in the accommodation portion is, the larger a diameter of the upstream discharge path is.

6. The image forming apparatus according to claim 1,
wherein the discharge transport member includes
an upstream transport portion that continues from one end of the first transport member and that transports the developer flowing out from the first transport path toward the first transport path, and
a downstream transport portion that continues from one end of the upstream transport portion and that transports the developer flowing out from the first transport path toward the outside of the accommodation portion, and
in each of the plurality of developing devices, the lower the fluidity of the developer to be accommodated in the accommodation portion is, the smaller a transport force generated by the upstream transport portion is.

7. The image forming apparatus according to claim 6,
wherein the discharge transport member includes
a rotary shaft that extends in the one direction,
an upstream blade portion that is provided in a spiral shape around the rotary shaft and that constitutes the upstream transport portion, and
a downstream blade portion that is provided in a spiral shape around the rotary shaft and that constitutes the downstream transport portion, and
in each of the plurality of developing devices, the lower the fluidity of the developer to be accommodated in the accommodation portion is, the smaller the number of turns of the upstream blade portion is.

8. The image forming apparatus according to claim 1,
wherein, in each of the plurality of developing devices, the accommodation portion and the discharge path are formed by a plurality of components, and
the lower the fluidity of the developer is, the more each of the plurality of developing devices is shaped to facilitate discharge of the developer to the outside of the accommodation portion with types of the components to be combined or a type of the discharge transport member to be combined with the plurality of components differing depending on the fluidity of the developer to be accommodated in the accommodation portion.

9. The image forming apparatus according to claim 8,
wherein the discharge transport member includes
an upstream transport portion that continues from one end of the first transport member and that transports the developer flowing out from the first transport path toward the first transport path, and
a downstream transport portion that continues from one end of the upstream transport portion and that transports the developer flowing out from the first transport path toward the outside of the accommodation portion,
the discharge path includes
an upstream discharge path that continues from the one end of the first transport path and in which the upstream transport portion is disposed, and
a downstream discharge path that continues from one end of the upstream discharge path and in which the downstream transport portion is disposed, and
in each of the plurality of developing devices, a plurality of types of first components that are different from each other in width of the first connection portion or a diameter of the upstream discharge path, a plurality of types of second components that are different from each other in ceiling height of the one end of the first transport path connected to the first connection portion, and a plurality of types of discharge transport members that are different from each other in transport force generated by the upstream transport portion are combined with each other in a different manner depending on the fluidity of the developer to be accommodated in the accommodation portion.

10. A developing device comprising:
an accommodation portion that accommodates a developer and that includes a first transport path extending in one direction, a second transport path disposed below the first transport path and extending in the one direction, a first connection portion connecting one end of the first transport path and one end of the second transport path to each other, and a second connection portion connecting the other end of the first transport path and the other end of the second transport path to each other;
a first transport member that is disposed in the first transport path and that transports the developer from one end to the other end in the one direction;
a second transport member that is disposed in the second transport path and that transports the developer from the other end to the one end in the one direction;
a discharge path that extends in the one direction from the one end of the first transport path and through which the developer flowing out from the first transport path is discharged to an outside of the accommodation portion; and
a discharge transport member that is disposed in the discharge path and that transports the developer flowing out from the first transport path,
wherein the accommodation portion and the discharge path are formed by a plurality of components, and
likelihood of discharge of the developer to the outside of the accommodation portion is changeable by changing types of the components to be combined or a type of the discharge transport member to be combined with the plurality of components.

11. The developing device according to claim 10,
wherein a ceiling height of the one end of the first transport path connected to the first connection portion, a width of the first connection portion, a diameter of the discharge path, or a transport force generated by the discharge transport member is changeable by changing the types of the components to be combined or the type of the discharge transport member to be combined with the plurality of components.
